(19) United States
(12) Patent Application Publication
(10) Pub. No.: US 2026/0061505 A1
(43) Pub. Date: Mar. 5, 2026

(54) CUTTING BLADE FOR A CUTTING TOOL

(71) Applicant: Cedric Williams, Hacienda Heights, CA (US)

(72) Inventor: Cedric Williams, Hacienda Heights, CA (US)

(21) Appl. No.: 19/312,704

(22) Filed: Aug. 28, 2025

Related U.S. Application Data
(60) Provisional application No. 63/688,518, filed on Aug. 29, 2024.

(51) Int. Cl. B23D 59/00; B23D 61/00

(52) U.S. Cl. CPC B23D 59/002; B23D 61/006

(57) ABSTRACT

A cutting blade for a cutting tool has a central mounting portion adapted to engage with a tool housing, and a blade edge extending outwardly from the central mounting portion, the blade edge being adapted for cutting. A ridge is positioned adjacent the blade edge, the ridge configured to limit the penetration depth of the cutting blade into a workpiece.

### CROSS-REFERENCE TO RELATED APPLICATIONS

This application for a utility patent claims the benefit of U.S. Provisional Application No. 63/688,518, filed Aug. 29, 2024.

### BACKGROUND OF THE INVENTION

### Field of the Invention

This invention relates generally to cutting tools, and more particularly to a cutting blade designed to control the depth of cuts made by oscillating and rotary cutting tools.

### Description of Related Art

Cutting tools are widely used in various applications to make precision cuts in different materials. Traditional cutting blades often lack mechanisms to control the depth of penetration, which can lead to inadvertent damage to underlying components such as electrical wiring or other sensitive parts within a workpiece.

Various attempts have been made in the art to address this issue by modifying blade design or implementing external depth control devices. However, these solutions often involve complex mechanisms or lack the versatility to be easily adapted to different cutting tools.

The prior art teaches cutting blades with enhanced cutting capabilities and blades designed for specific materials. However, the prior art does not teach a cutting blade incorporating an integrated ridge to limit penetration depth, thereby allowing precision cuts without complex adjustments. The present invention fulfills these needs and provides further advantages as described in the following summary.

### SUMMARY OF THE INVENTION

The present invention teaches certain benefits in construction and use which give rise to the objectives described below.

The present invention provides a cutting blade for a cutting tool. The cutting blade comprises a central mounting portion adapted to engage with a tool housing, and a blade edge extending outwardly from the central mounting portion, the blade edge being adapted for cutting. A ridge is positioned adjacent the blade edge, the ridge configured to limit the penetration depth of the cutting blade into a workpiece.

A primary objective of the present invention is to provide a cutting blade for a cutting tool having advantages not taught by the prior art.

Another objective is to provide a cutting blade for a cutting tool having a ridge that enables precise and consistent cutting depth control.

A further objective is to provide a cutting blade compatible with multiple cutting tools.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of an oscillating cutting tool that includes a cutting blade according to one embodiment of the present invention;

FIG. 2 is a front perspective view of the cutting blade;

FIG. 3 is a rear perspective view thereof;

FIG. 4 is a side elevational view thereof;

FIG. 5 is a plan view thereof; and

FIG. 6 is a perspective view of a second embodiment of the cutting tool.

### DETAILED DESCRIPTION OF THE INVENTION

The above-described drawing figures illustrate the invention, a cutting blade that is adapted for use with a cutting tool. Critically, the cutting blade includes a ridge for physically blocking the depth that the cutting tool penetrates a workpiece, enabling a user to make cuts to a predetermined depth, without penetrating further and potentially damaging internal components of the workpiece being cut.

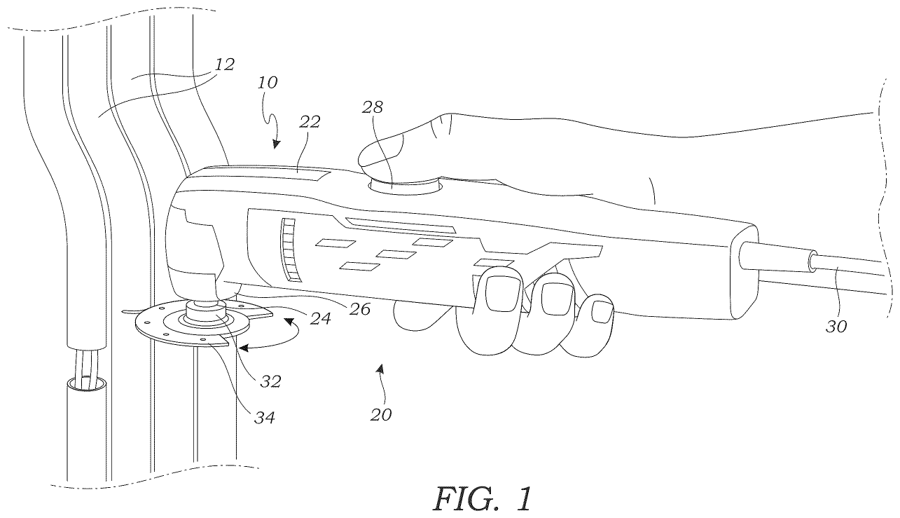

FIG. 1 is a perspective view of a cutting tool 20 that includes a cutting blade 10 according to one embodiment of the present invention. As shown in FIG. 1, in this embodiment, the cutting tool 20 is in the form of an oscillating cutting tool which includes a tool housing 22 that contains a motor and a power source, such as a power cord, battery, or equivalent element operably connected to a cutting blade 10 for powering the cutting blade 10 at a suitable rpm. The blade 10 is adapted to cut into a workpiece 12, which is illustrated here as an electrical conduit. In this embodiment, an outer protective conduit surrounds various wires, and the tool is being used to cut the outer protective conduit without cutting into the various wires within. However, any desired workpiece may be cut using the tool blade 10, and alternative uses should be considered within the scope of the present invention.

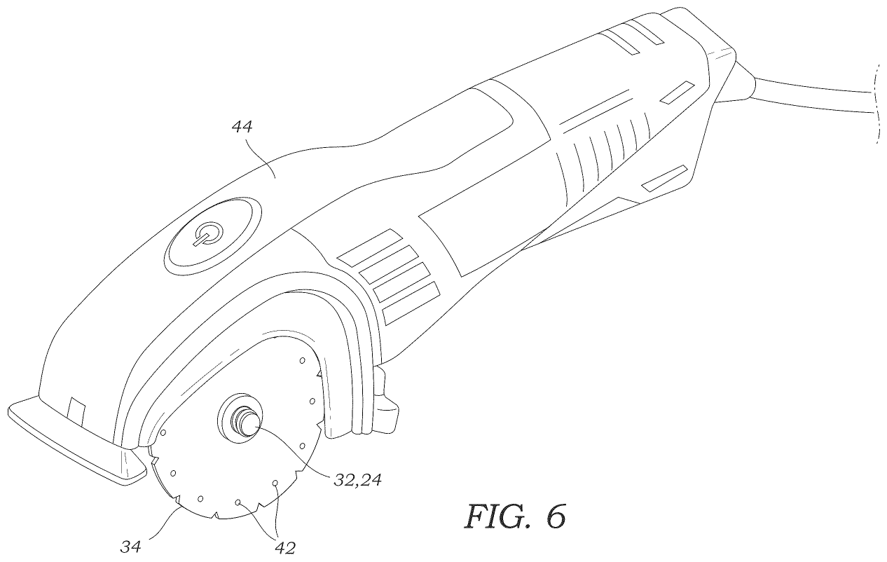

As shown in FIG. 1, the tool housing 22 may be elongate for use as a handheld device. However, any suitable tool housing may be constructed, as long as it is compatible with the cutting blade 10 described herein, and for use by a person. For example, the cutting blade 10 may be mounted on a rotary cutting tool 44, as shown in FIG. 6 and discussed further below. In various embodiments, the cutting blade 10 may be mounted to the tool housing 22 via a mandrel 24 that connects to a rotary element 26, wherein the mandrel 24 sets the cutting blade 10 to provide clearance for making cuts. Power to the cutting blade 10 may be actuated by a button 28 located anywhere on the housing 22, or alternatively a switch or similar mechanism. The cutting tool 20 may include a power cord 30, or it may instead or additionally be used with a battery or other power source. The motor may be provided as a brushed or a brushless motor, depending on the desired use. Other features of the tool housing 22 may include a guard lever, handle portion, vent openings, dust collector, speed/setting controls, electric brake, anti-kickback features, laser guide, cooling fan, etc., or any other features commonly associated with this type of invention. Since the general structure and components of motorized cutting tools are well-known in the art, the tool housing is not described further herein.

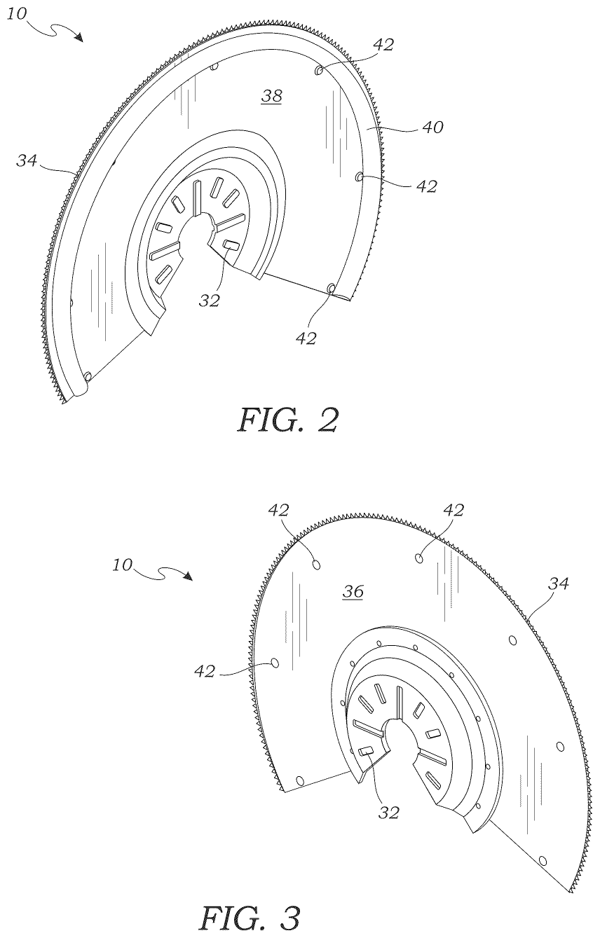

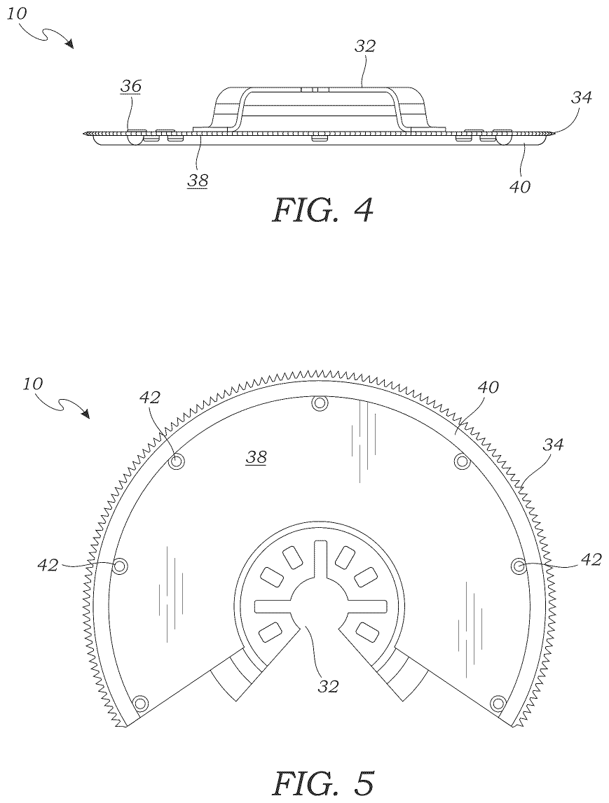

FIG. 2 is a front perspective view of the cutting blade 10, FIG. 3 is a rear perspective view thereof, FIG. 4 is a side elevational view thereof, and FIG. 5 is a plan view thereof. As shown in FIGS. 2-5, the cutting blade 10 comprises a central mounting portion 32 that extends outwardly to a blade edge 34, the cutting blade 10 further having a first surface 36 and a second surface 38. The cutting blade 10 may be generally semi-circular as in the present embodiment, or alternatively could be annular, squared, or any other shape desired by one skilled in the art that is functional for use as described herein. The blade edge 34 is adapted for cutting, and may be a generally straight or curved blade edge, as illustrated, or it may be serrated, if desired. In some embodiments, the blade edge may include an added grit (such as carbide), or similar texture, and this and similar features should be considered within the scope of the present invention.

As shown in FIGS. 1-2, and 4-5, the cutting blade 10 includes a ridge 40 adjacent the blade edge 34 that prevents the cutting blade 10 from penetrating past a certain depth into the workpiece 12. In this embodiment, the ridge 40 of the cutting blade 10 is in the form of a wire mounted to the second surface 38, but alternatively may be mounted to the first surface 36, or both surfaces. The ridge 40 may be especially useful in protecting electrical wiring that may be stored within the conduit 12 (FIG. 1) while cutting through the conduit 12. In such a case, the distance between the ridge 40 and the edge 34 of the cutting blade 10 is the same as the thickness of the conduit 12. This enables a user to cut through the conduit 12, without the danger of cutting into the wiring inside the conduit 12. Obviously, any other workpiece may also be cut using the cutting blade 10.

In this embodiment, the ridge 40 is attached to the cutting blade 10 via a plurality of weld points 42 adjacent the entire length of the blade edge 34. The weld points 42 provide secure attachment, and may further provide a degree of resistance by functioning as reinforcement against pressure from an object being cut. However, in alternative embodiments, the ridge 40 may be attached via another means, e.g., an adhesive, a mechanical fastener such as pins/bolts/staples, etc. Furthermore, in some cases the ridge 40 may be molded into the cutting blade 10, without need for later attachment. The distance between the ridge 40 and the blade edge 34 should be consistent along the entirety of the cutting edge, or it may vary depending in different portions of the cutting blade to allow variation of the depth of cut. In some implementations, the present invention is provided in a set (not shown), wherein each blade within the set has a ridge mounted at a different distance from the given blade edge. The ridge 40 may be provided in any suitable thickness or height, and may be generally tubular in shape, or include angular side surfaces, and further may be constructed of any material capable of limiting penetration of the cutting blade during cuts.

As illustrated, the central mounting portion 32 of the cutting blade 10 is adapted to engage with the tool housing 22, usually to the mandrel 24 or equivalent structure. While one example of the central mounting portion 32 is shown, any suitable mounting portion may be constructed. For example, the central portion 32 may be generally planar and aligned with the rest of the cutting blade 10, or it may extend from the first surface 36 and/or the second surface 38 as illustrated. The central mounting portion 32 may include any necessary slots, grooves, threads, etc., for engagement with the tool housing 22. It may be secured by a bolt or similar mechanism, or it may lock into place via grooves/cutouts, or mount via any other functional mechanism. Once secured, the oscillating cutting tool 20 may be powered on to make cuts. The oscillating cutting tool 20 may then be used to cut any desired workpieces, wherein the ridge 40 limits the depth of each cut.

FIG. 6 is a perspective view of a second embodiment 44 of the cutting tool, wherein the cutting tool is a rotary cutting tool 44. In the embodiment of FIG. 6, the cutting blade 10 is generally circular instead of semicircular, wherein shoulders/gullets along the blade edge are wider than in the embodiment of FIGS. 1-5. As previously discussed, any desired form of blade edge and/or central mounting portion may be constructed, as long as the ridge 40 on the cutting blade 10 functions to guide the depth of cuts. In this embodiment, the ridge 40 is mounted to the second surface 38 of the cutting blade 10, so only the weld points 42 are visible, but in other embodiments this may be reversed. In use, the cutting tool 10/44 of the present invention may be used in any instance where precision cutting is required.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A cutting blade for a cutting tool, the cutting blade comprising:
a central mounting portion adapted to engage with a tool housing;
a blade edge extending outwardly from the central mounting portion, the blade edge being adapted for cutting; and
a ridge positioned adjacent the blade edge, the ridge configured to limit the penetration depth of the cutting blade into a workpiece.

2. The cutting blade of claim 1, wherein the ridge is in the form of a wire mounted to a surface of the cutting blade via a plurality of weld points.

3. The cutting blade of claim 1, wherein the cutting blade includes a first surface and a second surface, and the second surface includes the ridge.

4. The cutting blade of claim 1, wherein the ridge is attached via an adhesive.

5. The cutting blade of claim 1, wherein the ridge is attached via pins, bolts, or staples.

6. The cutting blade of claim 1, wherein the ridge is molded into the cutting blade.

7. A cutting tool comprising:
a motorized tool housing operably connected to a cutting blade;
wherein the cutting blade includes a central mounting portion, a blade edge, and a ridge adjacent to the blade edge; and
wherein the ridge is configured to limit the penetration depth of the cutting blade into a workpiece.

8. The cutting tool of claim 6, wherein the tool housing is elongate for use as a handheld device.
